(19) United States
(12) Patent Application Publication
(10) Pub. No.: US 2009/0243336 A1
(43) Pub. Date: Oct. 1, 2009

(54) FRAME STRUCTURE OF AUTOMOTIVE VEHICLE

(75) Inventors: Hiromasa HONJI, Hiroshima (JP); Hiroaki TAKESHITA, Hiroshima (JP); Michinari WATANABE, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/389,879

(22) Filed: Feb. 20, 2009

(30) Foreign Application Priority Data
Mar. 28, 2008 (JP) 2008-085191

(51) Int. Cl. B62D 21/15; B60R 21/00

(52) U.S. Cl. 296/187.09

(57) ABSTRACT

A reinforcement member is provided inside a frame member at a space which includes a bend portion operative to bend in such a manner that the reinforcement member comes to contact an inner face of an inside side face portion of the frame member as the frame member bends at the bend portion. Accordingly, the amount of energy absorption even after the bending start of the frame member can be properly increased.

### BACKGROUND OF THE INVENTION

The present invention relates to a frame structure of an automotive vehicle, and in particular, relates to a structure for impact absorption.

Japanese Patent Laid-Open Publication No. 2003-220977, for example, discloses a frame structure of an automotive vehicle, in which there is provided a frame member which extends substantially straightly in a vehicle longitudinal direction and connects to a dash panel at its rear end portion, the frame member having a bend portion which is operative to bend in a vehicle width direction when a longitudinal impact load acts thereon. According to this structure, an impact energy inputted to the frame member is absorbed by bending of the frame member.

Herein, according to the structure disclosed in the above-described patent publication, since the frame member has a closed cross section which extends in the longitudinal direction, the amount of energy absorption may be greater at a bending start compared to a case in which the frame member has no closed cross section. However, the increase degree of this amount of energy absorption tends to reduce considerably after the bending start, so that there is a concern that the impact energy could not be absorbed properly.

### SUMMARY OF THE INVENTION

An object of the present invention is to provide a frame structure which can properly increase the amount of energy absorption even after the bending start of the frame member.

According to the present invention, there is provided a frame structure of an automotive vehicle, comprising a hollow frame member provided so as to extend in a vehicle longitudinal direction and connect to a dash panel at a rear end portion thereof, the frame member having both-side side face portions and upper and lower horizontal face portions so as to have a substantially-rectangular cross section, the frame member having a bend portion which is operative to bend toward one side in a vehicle width direction when a longitudinal impact load acts thereon, and a reinforcement member provided inside the frame member at a space which includes the bend portion of the frame member in such a manner that the reinforcement member is off an inner face of one of the side face portions of the frame member which is located on a side opposite to the one side toward which the bend portion bends in an initial state and the reinforcement member comes to contact the inner face of the one of the side face portions of the frame member as the frame member bends at the bend portion during an action of the impact load.

According to the present invention, the reinforcement member provided inside the frame member at the space including the bend portion of the frame member contacts the inner face of the one of the side face portions of the frame member as the frame member bends at the bend portion during the action of the impact load. Thereby, the bending of the frame member can be properly restrained from progressing abruptly after contacting. Further, since the reinforcement member is deformed after the contacting, the amount of energy absorption can be properly increased with the deformation of the reinforcement member.

According to an embodiment of the present invention, the reinforcement member is configured such that a portion thereof which is operative to come to contact the frame member is located at a position which is closer to the one of the side face portions of the frame member than the other of the side face portions of the frame member. Thereby, the contacting of the reinforcement member and the frame member can be made occur as properly soon as possible. Thus, the amount of energy absorption can be increased further properly.

According to another embodiment of the present invention, the reinforcement member comprises both-side side face portions and a horizontal face portion which is provided at either a lower side or an upper side between the both-side side face portions thereof so as to have a U-shaped or reverse-U-shaped cross section, and the reinforcement member is configured such that one of the side face portions of the reinforcement member which is located on the one side toward which the bend portion bends is joined to the one of the side face portions of the frame member and the other of the side face portions of the reinforcement member comes to contact the inner face of the one of the side face portions of the frame member as the bend portion bends during the action of the impact load. Thereby, the increase of the energy absorption can be achieved with a simpler structure of the reinforcement member. Further, the one of the side face portions of the reinforcement member may be easily attached to the one of the side face portions of the frame member via welding.

According to another embodiment of the present invention, the reinforcement member is attached to the one of the side face portions of the frame member in such a manner that a closed cross section is formed together with the one of the side face portions of the frame member. Thereby, the rigidity of the reinforcement member is increased, so that the amount of energy absorption with the contacting can be further increased.

According to another embodiment of the present invention, the reinforcement member is attached to the one of the side face portions of the frame member in such a manner that a closed cross section is formed therewith singly. Thereby, the increase of the amount of energy absorption can be achieved regardless of the shape, thickness or the like of the frame member.

According to another embodiment of the present invention, the reinforcement member forms two closed cross sections together with the frame member or singly in such a manner that the two closed cross sections extend in the vehicle longitudinal direction and overlap with each other in the vehicle width direction. Thereby, the amount of energy absorption with the contacting can be further increased. Further, since the two closed cross sections overlap with each other in the vehicle width direction, the rigidity for the bending in the vehicle width direction is not increased improperly compared to a case in which the two closed cross sections are configured to overlap with each other in the vertical direction. Thus, the proper energy absorption can be achieved even in a case in which the frame member has a relatively narrow width.

According to another embodiment of the present invention, the frame member is comprised of a pair of frame members which are located away from each other in the vehicle width direction, a vehicle constituting member is provided between the pair of frame members, and the pair of frame members have respective bend portions which are operative to bend outward of the vehicle respectively. Thereby, the frame member which has bent does not contact the vehicle constituting member. Thus, the impact energy can be properly absorbed avoiding any contact with the vehicle constituting member provided between the frame members.

According to another embodiment of the present invention, the bend portion of the frame member comprises a bead which is formed at the one of the side face portions of the frame member so as to extend substantially vertically in such a manner that the bead is recessed toward the one side in the vehicle width direction which is a bending direction of the bend portion. Thereby, the bending point or direction can be stabilized.

According to another embodiment of the present invention, a reinforcement member is provided substantially in the vehicle longitudinal direction in such a manner that a front end portion thereof connects to the frame member at a location which is right behind a rear end of the reinforcement member and a rear end portion thereof connects to a vehicle-body constituting member behind the frame member. Thereby, the rear end portion of the frame member can be reinforced. Further, part of the energy absorption can be performed by the reinforcement member, so that flexibility of setting the longitudinal length of the reinforcement member and the like can be improved.

According to another embodiment of the present invention, the bend portion of the frame member is comprised of a plurality of portions which have different bending amounts, and the reinforcement member is provided only for one of the portions which has the greatest bending amount. Thereby, the amount of energy absorption can be increased efficiently with restraint of the weight increase caused by the reinforcement member.

Other features, aspects, and advantages of the present invention will become apparent from the following description which refers to the accompanying drawings.

### BRIEF DESCRIPTION OF THE DRAWINGS

FIG. 1 is a perspective view showing a frame structure of an automotive vehicle according to a first embodiment of the present invention, when viewed from the vehicle front.

FIG. 2 is a view along an arrow A of FIG. 1.

FIG. 3 is a view along an arrow B of FIG. 2.

FIG. 4 is a sectional view taken along line C-C of FIG. 2.

FIG. 5 is a sectional view taken along line D-D of FIG. 2.

FIG. 6 is an explanatory diagram of an action of bending of a front side frame.

FIG. 7 is a sectional view taken along line E-E of FIG. 2 at the bending of the front side frame.

FIG. 8 is a sectional view taken along line C-C of FIG. 2 at the bending of the front side frame.

FIG. 9A is a load characteristic diagram and FIG. 9B is an energy-absorption-amount characteristic diagram at the bending of the front side frame.

FIG. 10 is a sectional view according to a second embodiment, which corresponds to FIG. 4.

FIG. 11 is a sectional view according to a third embodiment, which corresponds to FIG. 4.

FIG. 12 is a sectional view according to a fourth embodiment, which corresponds to FIG. 4.

FIG. 13 is a sectional view according to a fifth embodiment, which corresponds to FIG. 4.

### DETAILED DESCRIPTION OF THE INVENTION

Hereinafter, a front body structure of an automotive vehicle according to preferred embodiments of the present invention will be described.

### Embodiment 1

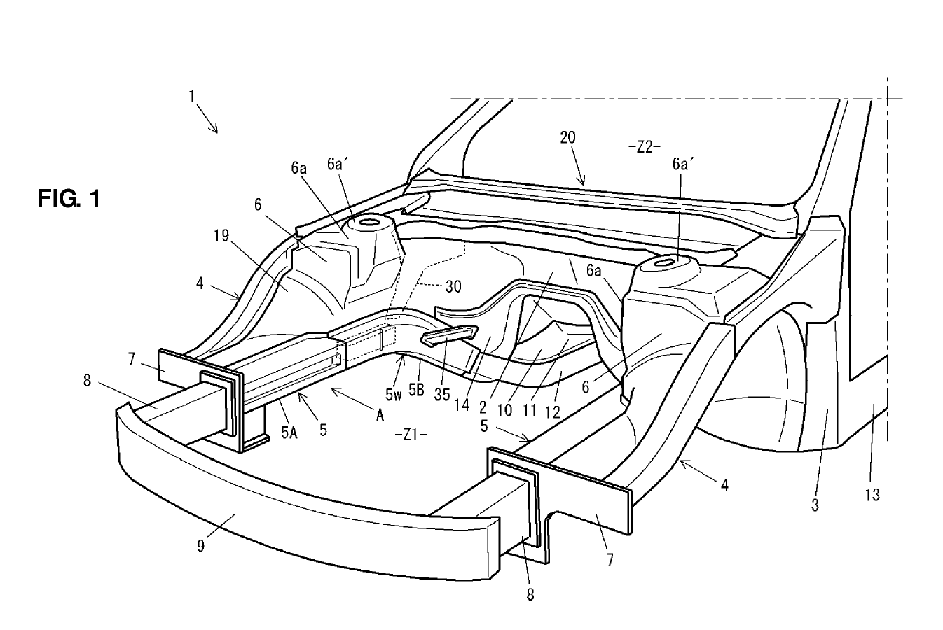

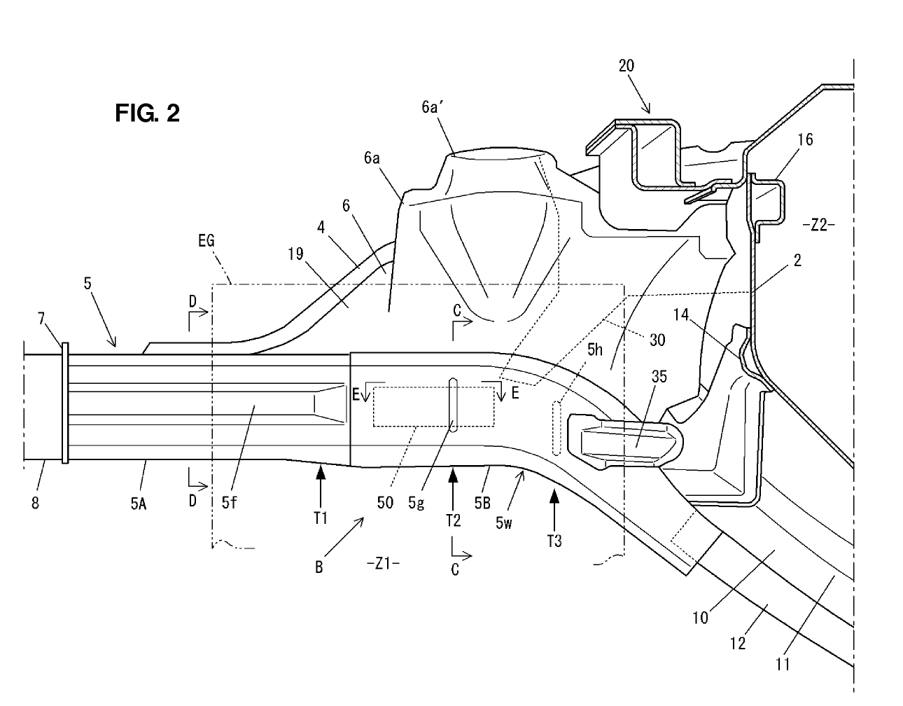

As shown in FIGS. 1 and 2, a dash panel 2 which partitions an engine room Z1 with an engine EG from a vehicle compartment Z2 in which a passenger is present is provided at a front portion of an automotive vehicle 1 of the present embodiment.

A pair of hinge pillars 3 (only one of them is illustrated) which extends vertically and pivotally supports front doors (not illustrated) is provided at both-side end portions of the dash panel 2.

A pair of apron reinforcements 4, 4 extends forward from upper end portions of the hinge pillars 3. A pair of front side frames 5, 5 extends in a vehicle longitudinal direction in parallel to the apron reinforcements 4, 4 in a plan view so as to be away from each other in a vehicle width direction. A wheel house 6 for a front wheel is provided between the apron reinforcement 4 and the front side frame 5 in the vehicle width direction.

Plates 7, 7, which are of a plate shape, are attached to respective front end portions of the front side frames 5 and the apron reinforcements 4. A bumper reinforcement 9 is attached to the right and left plates 7, 7 via crush cans 8, 8 so as to extend in the vehicle width direction. The crush cans 8, 8 are configured to be crushable in the vehicle longitudinal direction when a longitudinal impact load acts thereon.

A lower portion of the dash panel 2 curves rearward, and its lower end portion connects to a front end portion of a floor panel 10. A tunnel portion 11 is provided at the lower portion of the dash panel 2 and the floor panel 10 so as to extend longitudinally at the central portion in the vehicle width direction and project upward.

A rear portion of the front side frame 5 curves downward beside the wheel house 6, and its lower end portion connects to a front end portion of a floor frame 12 which extends in the vehicle longitudinal direction below the floor panel 10 (FIG. 2). The floor frame 12, which has a U-shaped cross section, forms a closed cross section which extends in the vehicle longitudinal direction together with the floor panel 10.

A side sill 13 extends rearward from a lower end portion of the front hinge pillar 3. The side sill 13 has a closed cross section which extends in the vehicle longitudinal direction.

A lower dash cross member 14 and an upper dash cross member 16 are respectively provided at the lower portion and the upper portion of the dash panel 2 so as to interconnect the right and left hinge pillars 3, 3. These cross members 14, 16 have a U-shaped cross section and form a closed cross section along with the dash panel 2.

The wheel house 6 is formed by making the rear portion of an apron panel 19 project upward. The apron panel 19 connects to the apron reinforcement 4 at its outer end, and it connects to the front side frame 5 at its inner end. At an upper end of the wheel house 6 is provided a suspension tower portion 6a which is formed by the apron panel 19 projecting upward.

A cowl portion 20 which has a closed cross section extending in the vehicle width direction is formed at the upper portion of the dash panel 2. The apron reinforcement 4 has a substantially-rectangular closed cross section which extends in the vehicle longitudinal direction.

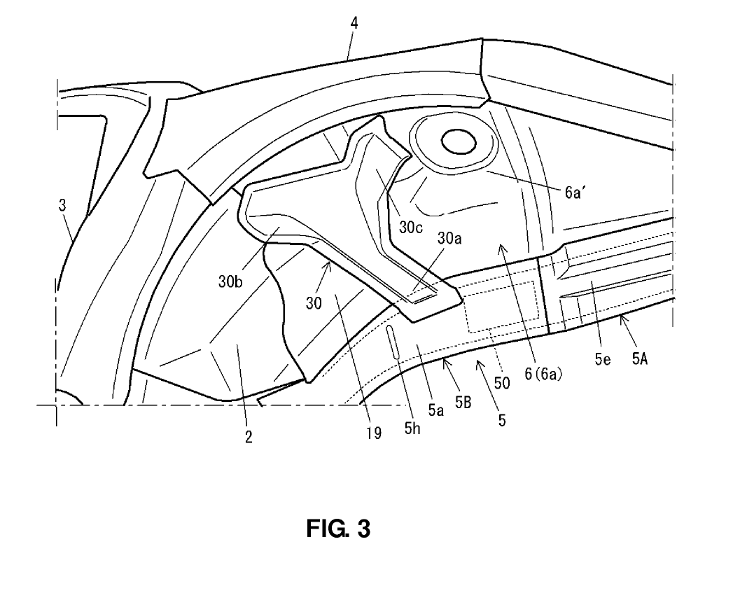

In the present embodiment, as shown in FIG. 3, a reinforcement member 30 is provided at a back face of the apron panel 19 at the wheel house 6 which is on an opposite side to the engine room Z1.

The reinforcement member 30 connects to an outer member 51 (facing toward the inside of the wheel house 6) of the front side frame 5 at its front end portion 30a, and extends obliquely rearward and upward. A rear side portion of the reinforcement member 30 branches to a rear portion and an upper portion. An end portion 30b of the rear portion connects to the dash panel 2 (vehicle body member), and an end portion 30c of the upper portion connects to an inner face of a top portion 6a′ of the suspension tower portion 6a. The reinforcement member 30 has a substantially U-shaped cross section which opens toward the inside of the vehicle, and forms a closed cross section along with the apron panel 19.

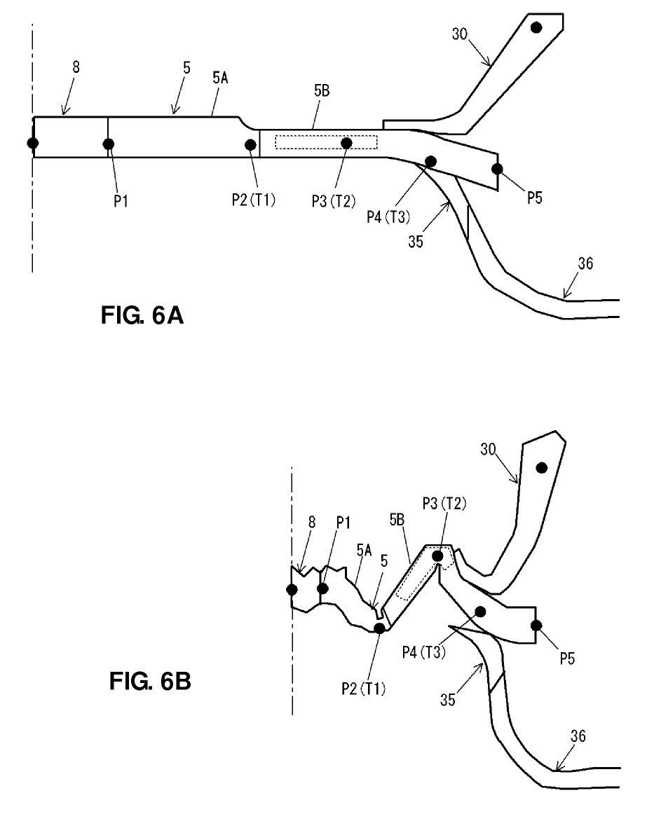

Further, as apparent from FIGS. 1 and 2, a second reinforcement member 35 with a U-shaped cross section is provided so as to interconnect the rear portion of the front side frame 5 and the lower dash cross member 14. Further, as shown in FIG. 6 which will be described later, a front end portion of a tunnel frame 36 which extends substantially in the vehicle longitudinal direction along the tunnel portion 11 connects to a rear end portion of the second reinforcement member 35.

Hereinafter, the structure of the front side frame 5 will be described specifically.

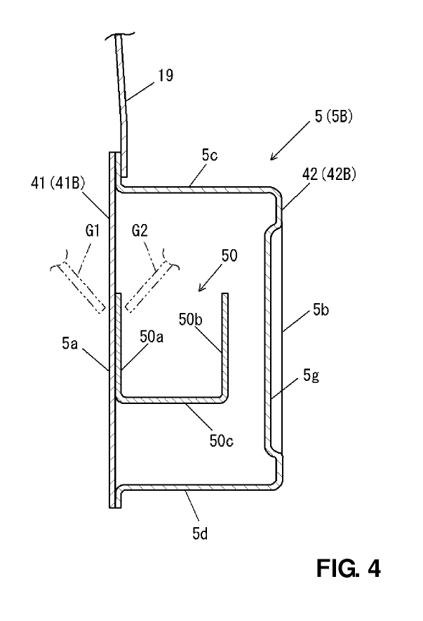

The front side frame 5 is, as shown in FIG. 4, formed by joining an outside member 41 which is of a flat plate shape and located outward of the vehicle to an inside member 42 which has a U-shaped cross section and is located inward of the vehicle. Thus, the front side frame 5 has left and right side face portions 5a, 5b and upper and lower horizontal face portions 5c, 5d so as to have a substantially-rectangular cross section which extends in the vehicle longitudinal direction.

Herein, the front side frame 5 comprises a front portion 5A in front of the suspension tower portion 6a and a rear portion 5B in back of the suspension tower portion 6a as apparent from FIGS. 1 and 2. The front and rear portions 5A, 5B are made from different materials from each other. For example, the front portion 5A may be made from a material, such as a high-tension material, which can maintain a specified rigidity at a normal condition and collapse like a bellows shape when receiving an impact load acting. Meanwhile, the rear portion 5B may be made from a thicker material so that the load resistance of this portion 5B can be greater than that of the front portion 5A. That is, the rear portion 5B does not collapse so easily compared to the front portion 5A.

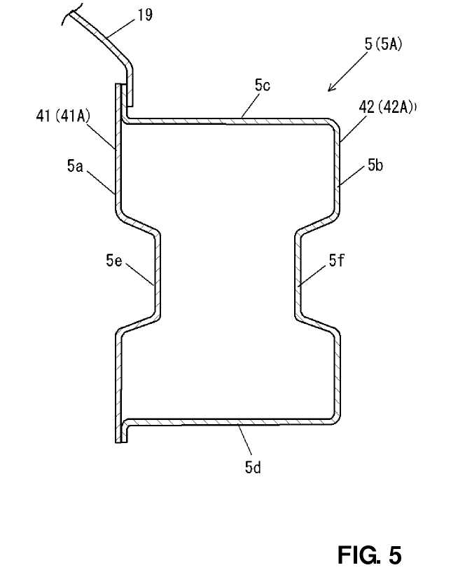

Further, at an outside member 41A and an inside member 42A of the front portion 5A are respectively formed beads 5e, 5f which extend in the vehicle longitudinal direction as apparent from FIGS. 1, 2 and 5. These beads 5e, 5f are provided to absorb the impact energy greatly when the front portion 5A of the front side frame 5 collapses in the vehicle longitudinal direction.

As shown in FIGS. 1 and 4, the width (length in the vehicle width direction) of the rear portion of the front portion 5A of the front side frame 5 becomes narrow gradually. Accordingly, when the impact load acts on the front side frame 5 from the vehicle front, this rear portion of the front portion 5A tends to bend outward (toward the vehicle outside) easily. Thus, a bend portion T1 which is operative to bend outward is provided at the rear portion of the front portion 5A of the front side frame 5 as shown in FIGS. 2 and 6.

Further, as shown in FIG. 2, a bead 5g which extends vertically is formed at the inside side face portion 5b of the front side frame 5 beside the suspension tower portion 6a. The bead 5g is recessed outward (toward the vehicle outside) as shown in FIG. 4, so that when the impact load acts on the front side frame 5 from the vehicle front, the front side frame 5 bends outward with a bending point of the bead 5g. Thus, the bend portion T2 is formed by the bead 5g.

Further, as shown in FIGS. 2 and 3, a bead 5h which extends vertically is formed at the outside side face portion 5a of the front side frame 5 at a curve portion 5w. The bead 5h is recessed inward (toward the vehicle inside) so that when the impact load acts on the front side frame 5 from the vehicle front, the front side frame 5 bends outward with a bending point of the bead 5h. Thus, the bend portion T3 is formed by the bead 5h.

According to the above-described structure, when the impact load is inputted to the bumper reinforcement 9 at a frontal collision or the like of the automotive vehicle 1, the impact load acts on the front side frames 5, 5 via the crush cans 8, 8.

Then, each crush can 8 collapses in the vehicle longitudinal direction as shown in 6A, which shows its initial state, and 6B. As described above, the front portion (longitudinal positions P1-P2) of the front side frame 5 which is in front of the suspension tower portion 6a collapses in the longitudinal direction, and the front side frame 5 bends outward at the bend portions T1, T2 and T3 (longitudinal positions P2, P3 and P4). Specifically, a specified portion of the front side frame 5 between the longitudinal positions P2 and P4 bends outward at the bend portion T2 (longitudinal position P3). Part of the impact load is absorbed by this collapsing and bending. Herein, the longitudinal position P1 is a position of the front end of the front side frame 5, the longitudinal position P2 is a position in which the width of the front side frame 5 reduces (bend portion T1), the longitudinal position P3 is a position of the bead 5g (bend portion T2), the longitudinal position P4 is a position of the bead 5h (bend portion T3), and the longitudinal position P5 is a position of the rear end of the front side frame 5.

Further, since the reinforcement member 30 is provided, part of the impact load is dispersed to the dash panel 2 and the top portion 6a′ of the suspension tower 6a. As a result, it is prevented that the frame 5 is deformed vertically or broken at the curve portion 5w.

Further, since the second reinforcement member 35 is provided, it is prevented that the front side frame 5 bends inward at the bend portion T3, so that the front side frame 5 can be made bend outward surely.

Also, since the left and right front side frames 5, 5 bend outward respectively, the frames 5, 5 which have bent does not contact the engine EG. In other words, the impact energy can be absorbed without contacting the engine EG provided between the left and right frames 5, 5.

Also, since the bend portion T2 is comprised of the bead 5g which is formed at the inside face portion 5b of the front side frame 5 so as to extend vertically in such a manner that the bead 5g is recessed outward, the bending point and direction is stabilized.

Herein, in the present embodiment, as shown in FIG. 2, a reinforcement member 50 is provided inside the front side frame 5 at a space which includes the above-described bend portion T2 of the front side frame 5. The reinforcement member 50 is provided only for the bend portion T2 which has the greatest bending amount among the bend portions T1-T3.

The reinforcement member 50 comprises, as shown in FIG. 4, left and right side face portions 50a, 50b and a horizontal face portion 50c which is provided at a lower side between the side face portions 50a, 50b so as to have a U-shaped cross section which opens upward.

The outside side face portion 50a of the reinforcement member 50 is joined to the outside face portion 5a of the front side frame 5. Meanwhile, the inside side face portion 50b is located at a position which is closer to the inside side face portion 5b of the front side frame 5 than the outside side face portion 5a.

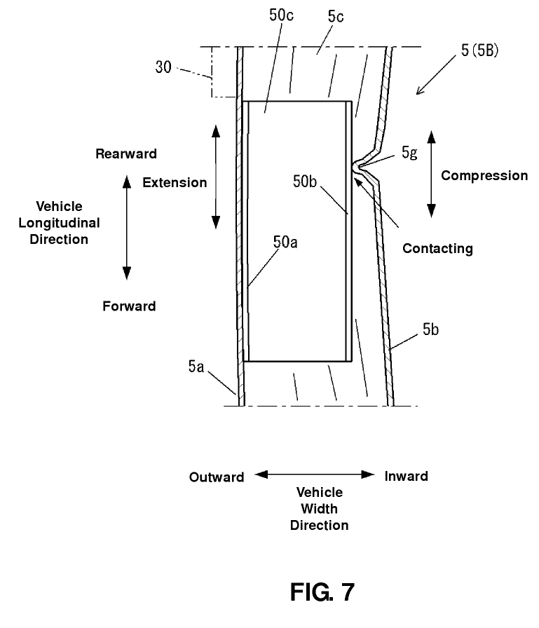

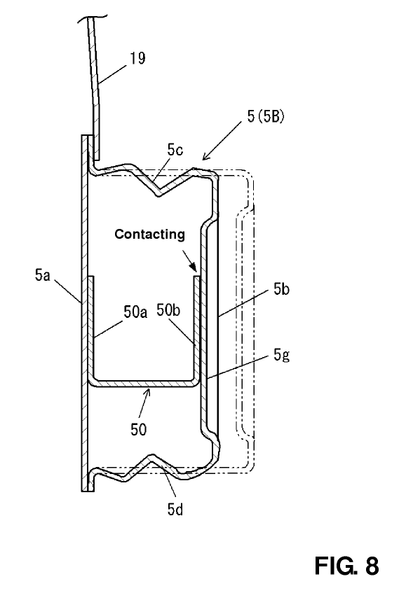

Herein, when the front side frame 5 bends outward at the bend portion T2, as shown in FIG. 7, a force of an extension direction in the vehicle longitudinal direction is applied to the outside side face portion 5a and a force of a compression direction is applied to the inside side face portion 5b. Since the reinforcement member 50 is provided at the outside side face portion 5a, the stress concentrates in the area around the bead 5g of the inside side face portion 5b. As a result, as shown in FIG. 8 as well, the horizontal face portions 5c, 5d are deformed, and the tip of the bead 5g comes to contact the inside side face portion 50b of the reinforcement member 50.

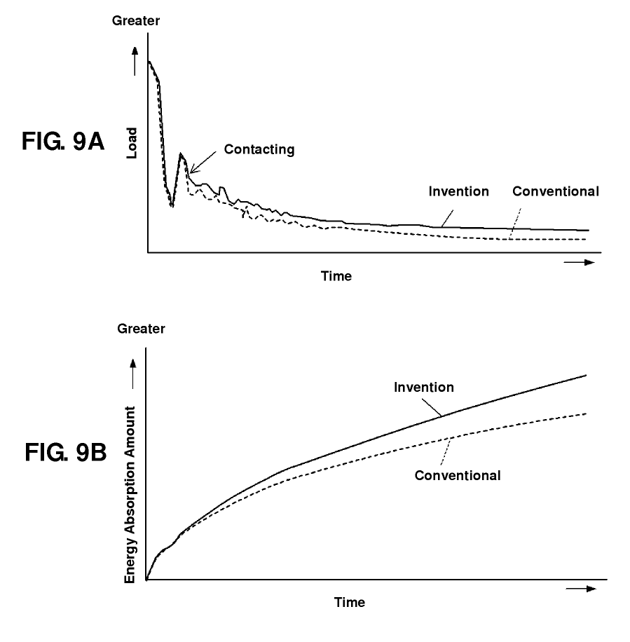

As described above, according to the present embodiment, since the reinforcement member 50 is provided inside the front side frame 5 at the space which includes the bend portion T2 in such a manner that the reinforcement member 50 comes to contact the inner face of the side face portion 5b of the front side frame 5 during the bending, the bending of the front side frame 5 can be properly restrained from progressing abruptly after contacting. Further, since the reinforcement member 50 is deformed after the contacting, the deformation load can be increased as shown in FIG. 9A and the amount of energy absorption can be properly increased as shown in FIG. 9B, compared to a case in which no reinforcement member is provided.

Further, since the inside side face portion 50b is located at the position which is closer to the inside side face portion 5b of the front side frame 5 than the outside side face portion 5b, the contacting of the reinforcement member 50 and the frame 5 can be made occur as properly soon as possible. Thus, the amount of energy absorption can be increased further properly.

Further, since the reinforcement member 50 is configured as described above, the increase of the energy absorption can be achieved with a simpler structure of the reinforcement member 50. Further, the outside side face portion 50a of the reinforcement member 50 may be easily attached to the outside side face portion 5a of the frame 5 via welding using guns G1, G2.

Also, since the reinforcement member 30 is provided substantially in the vehicle longitudinal direction in such a manner that its front end portion connects to the front side frame 5 at the location which is right behind the rear end of the reinforcement member 50 and its rear end portion connects to the dash panel 2 and the suspension tower portion 6a behind the frame 5, the rear end portion of the frame 5 can be reinforced. Further, part of the energy absorption can be performed by the reinforcement member, so that flexibility of setting the longitudinal length of the reinforcement member 50 and the like can be improved.

Further, since the reinforcement member 50 is provided only for the bend portion T2 which has the greatest bending amount among the bend portions T1-T3, the amount of energy absorption can be increased efficiently restraining the weight increase by the reinforcement member 50.

While the reinforcement member 50 comprises the left and right side face portions 50a, 50b and the lower horizontal face portion 50c so as to have the U-shaped cross section in the present embodiment, it may be configured to have the both side face portions and an upper horizontal face portion so as to have a reverse-U-shaped cross section.

Hereinafter, other embodiments will be described. Herein, the structure except the reinforcement member is the same as the above-described first embodiment. The same structure is denoted by the same reference characters, and their descriptions will be omitted here.

### Embodiment 2

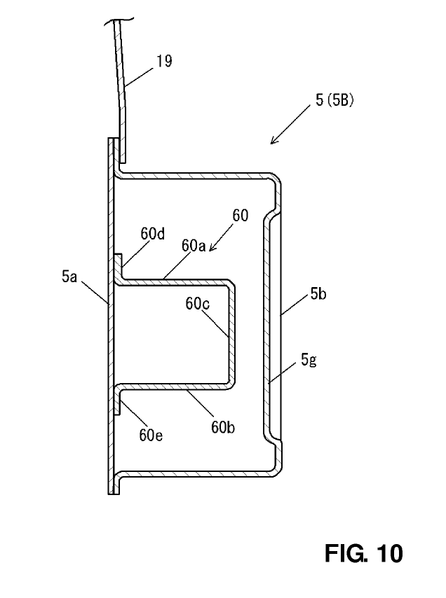

In a second embodiment, as shown in FIG. 10, a reinforcement member 60 comprises upper and lower horizontal face portions 60a, 60b, a side face portion 60c which is provided at inward end portions of the horizontal face portions 60a, 60b, and flange portions 60d, 60e which are provided at outward end portions of the horizontal portions 60a, 60b. Thus, the reinforcement member 60 has a U-shaped cross section which opens outward. The flange portions 60d, 60e are welded to the outside side face portion 5a of the front side frame, so that the reinforcement member 60 forms a closed cross section extending in the vehicle longitudinal direction together with the outside side face portion 5a.

The inside side face portion 60c is located at a position which is closer to the inside side face portion 5b of the front side frame 5 than the outside side face portion 5a. Thereby, the side face portion 60c of the reinforcement member 60 contacts the inner face of the inside side face portion 5b of the front side frame 5 as properly soon as possible when the front side frame 5 bends outward at the bend portion T2.

According to the second embodiment, since the reinforcement member 60 is attached to the outside side face portion 5a of the front side frame 5 so as to form the closed cross section extending in the longitudinal direction together with the outside side face portion 5a, the rigidity of the reinforcement member 60 is increased, so that the amount of energy absorption with the contacting can be further increased.

### Embodiment 3

A third embodiment will be described.

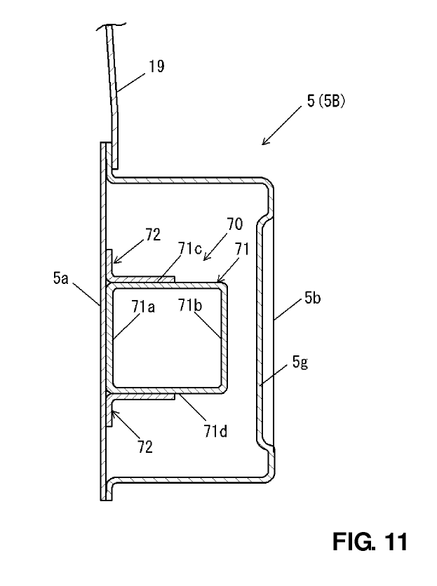

In the third embodiment, as shown in FIG. 11, a reinforcement member 70 comprises a rectangular pipe member 71 which comprises left and right side face portions 71a, 71b and upper and lower horizontal face portions 71c, 71d and has a closed cross section extending in the vehicle longitudinal direction and a pair of brackets 72, 72 which is fixed to outside portions of the horizontal face portions 71c, 71d. The brackets 72, 72 are welded to the outside side face portion 5a of the front side frame 5.

The inside side face portion 71b is located at a position which is closer to the inside side face portion 5b of the front side frame 5 than the outside side face portion 5a. Thereby, the side face portion 71b of the reinforcement member 70 contacts the inner face of the inside side face portion 5b of the front side frame 5 as properly soon as possible when the front side frame 5 bends outward at the bend portion T2.

According to the third embodiment, since the reinforcement member 70 is attached to the outside side face portion 5a of the front side frame 5 and singly forms the closed cross section extending in the longitudinal direction, the increase of the amount of energy absorption can be achieved regardless of the shape, thickness or the like of the front side frame 5.

### Embodiment 4

A fourth embodiment will be described.

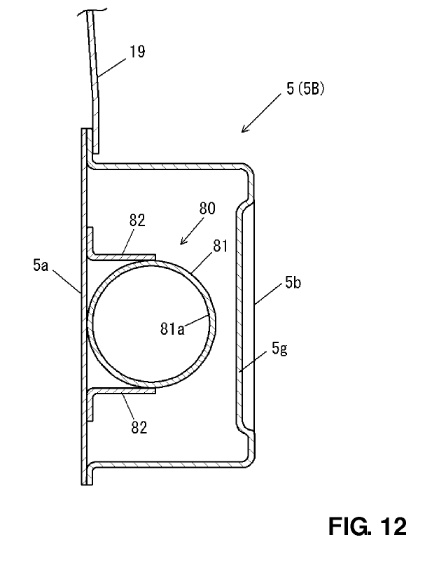

In the fourth embodiment, as shown in FIG. 12, a reinforcement member 80 comprises a circular pipe member 81 which has a closed cross section extending in the vehicle longitudinal direction and a pair of brackets 82, 82 which is fixed to upper and lower of the circular pipe member 81. The brackets 82, 82 are welded to the outside side face portion 5a of the front side frame 5.

An inside end portion 81a of the circular pipe member 81 is located at a position which is closer to the inside side face portion 5b of the front side frame 5 than the outside side face portion 5a. Thereby, the inside end portion 81a of the reinforcement member 80 contacts the inner face of the inside side face portion 5b of the front side frame 5 as properly soon as possible when the front side frame 5 bends outward at the bend portion T2.

According to the fourth embodiment, since the reinforcement member 80 is attached to the outside side face portion 5a of the front side frame 5 and singly forms the closed cross section extending in the longitudinal direction, the increase of the amount of energy absorption can be achieved regardless of the shape, thickness or the like of the front side frame 5 like the third embodiment.

### Embodiment 5

A fifth embodiment will be described.

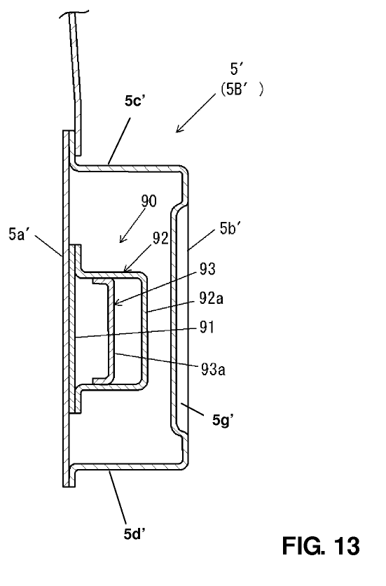

In the fifth embodiment, as shown in FIG. 13, the width of a front side frame 5′ is set to be narrower than that of the front side frame of the first through fourth embodiments for the reason of the size of vehicle. Accordingly, the amount of energy absorption by the front side frame 5′ itself is relatively small compared to the first through fourth embodiments. The fifth embodiment includes some measure against this matter.

A reinforcement member 90 has plural closed cross sections which extend in the vehicle longitudinal direction. Specifically, the reinforcement member 90 comprises an outside face member 91 which is attached to an outside side face portion 5a′ of the front side frame 5′ and provided in parallel to this face portion 5a′, a U-shaped-cross-section member 92 which is attached to the outside face member 91 and has a face portion 92a which is in parallel to an inside side face portion 5b′, and a section-partition member 93 which has a face portion 93a in parallel to the inside side face portion 5b′ operative to partition an inside space formed by these members 91, 92 into two parts in the vehicle width direction. Herein, the front side frame 5′ has its upper and lower horizontal face portions 5c′, 5d′ like the above-described front side frame 5. Also, a bead 5g′ is formed at the inner side face portion 5b′ likewise.

According to the fifth embodiment, since the reinforcement member 90 forms two closed cross sections together with the front side frame 5′ or singly in such a manner that the two closed cross sections extend in the vehicle longitudinal direction and overlap with each other in the vehicle width direction, the amount of energy absorption with the contacting can be further increased. Further, since the two closed cross sections overlap with each other in the vehicle width direction, the rigidity for the bending in the vehicle width direction is not increased improperly compared to a case in which the two closed cross sections are configured to overlap with each other in the vertical direction.

The present invention should not be limited to the above-described embodiments, and any other modifications and improvements may be applied in the scope of a sprit of the present invention.

What is claimed is:

1. A frame structure of an automotive vehicle, comprising:
a hollow frame member provided so as to extend in a vehicle longitudinal direction and connect to a dash panel at a rear end portion thereof, the frame member having both-side side face portions and upper and lower horizontal face portions so as to have a substantially-rectangular cross section, the frame member having a bend portion which is operative to bend toward one side in a vehicle width direction when a longitudinal impact load acts thereon; and
a reinforcement member provided inside said frame member at a space which includes the bend portion of the frame member in such a manner that the reinforcement member is off an inner face of one of the side face portions of the frame member which is located on a side opposite to said one side toward which the bend portion bends in an initial state and the reinforcement member comes to contact the inner face of the one of the side face portions of the frame member as the frame member bends at the bend portion during an action of the impact load.

2. The frame structure of an automotive vehicle of claim 1, wherein said reinforcement member is configured such that a portion thereof which is operative to come to contact said frame member is located at a position which is closer to said one of the side face portions of the frame member than the other of the side face portions of the frame member.

3. The frame structure of an automotive vehicle of claim 1, wherein said reinforcement member comprises both-side side face portions and a horizontal face portion which is provided at either a lower side or an upper side between the both-side side face portions thereof so as to have a U-shaped or reverse-U-shaped cross section, and the reinforcement member is configured such that one of the side face portions of the reinforcement member which is located on said one side toward which the bend portion bends is joined to said one of the side face portions of the frame member and the other of the side face portions of the reinforcement member comes to contact said inner face of the one of the side face portions of the frame member as the bend portion bends during the action of the impact load.

4. The frame structure of an automotive vehicle of claim 1, wherein said reinforcement member forms two closed cross sections together with the frame member or singly in such a manner that the two closed cross sections extend in the vehicle longitudinal direction and overlap with each other in the vehicle width direction.

5. The frame structure of an automotive vehicle of claim 1, wherein said frame member is comprised of a pair of frame members which are located away from each other in the vehicle width direction, a vehicle constituting member is provided between the pair of frame members, and the pair of frame members have respective bend portions which are operative to bend outward of the vehicle respectively.

6. The frame structure of an automotive vehicle of claim 1, wherein said bend portion of the frame member comprises a bead which is formed at said one of the side face portions of the frame member so as to extend substantially vertically in such a manner that the bead is recessed toward said one side in the vehicle width direction which is a bending direction of the bend portion.

7. The frame structure of an automotive vehicle of claim 6, wherein a reinforcement member is provided substantially in the vehicle longitudinal direction in such a manner that a front end portion thereof connects to said frame member at a location which is right behind a rear end of said reinforcement member and a rear end portion thereof connects to a vehicle-body constituting member behind the frame member.

8. The frame structure of an automotive vehicle of claim 1, wherein said bend portion of the frame member is comprised of a plurality of portions which have different bending amounts, and said reinforcement member is provided only for one of the portions which has the greatest bending amount.

9. A frame structure of an automotive vehicle, comprising:
a hollow frame member provided so as to extend in a vehicle longitudinal direction and connect to a dash panel at a rear end portion thereof, the frame member having both-side side face portions and upper and lower horizontal face portions so as to have a substantially-rectangular cross section, the frame member having a bend portion which is operative to bend toward one side in a vehicle width direction when a longitudinal impact load acts thereon; and
a reinforcement member provided inside said frame member at a space which includes the bend portion of the frame member in such a manner that the reinforcement member is off an inner face of one of the side face portions of the frame member which is located on a side opposite to said one side toward which the bend portion bends in an initial state and the reinforcement member comes to contact the inner face of the one of the side face portions of the frame member as the frame member bends at the bend portion during an action of the impact load,
wherein said reinforcement member is attached to said one of the side face portions of the frame member in such a manner that a closed cross section is formed together with the one of the side face portions of the frame member.

10. A frame structure of an automotive vehicle, comprising:
a hollow frame member provided so as to extend in a vehicle longitudinal direction and connect to a dash panel at a rear end portion thereof, the frame member having both-side side face portions and upper and lower horizontal face portions so as to have a substantially-rectangular cross section, the frame member having a bend portion which is operative to bend toward one side in a vehicle width direction when a longitudinal impact load acts thereon; and
a reinforcement member provided inside said frame member at a space which includes the bend portion of the frame member in such a manner that the reinforcement member is off an inner face of one of the side face portions of the frame member which is located on a side opposite to said one side toward which the bend portion bends in an initial state and the reinforcement member comes to contact the inner face of the one of the side face portions of the frame member as the frame member bends at the bend portion during an action of the impact load,
wherein said reinforcement member is attached to said one of the side face portions of the frame member in such a manner that a closed cross section is formed therewith singly.
